(19) United States
(12) Patent Application Publication
(10) Pub. No.: US 2019/0130041 A1
(43) Pub. Date: May 2, 2019

(54) HELIX SEARCH INTERFACE FOR FASTER BROWSING

(71) Applicant: Microsoft Technology Licensing, LLC, Redmond, WA (US)

(72) Inventors: Timothy Page McKee, Seattle, WA (US); Sarvesh Nagpal, Issaquah, WA (US); Kiraz Baysal, Seattle, WA (US); Manish Mittal, Redmond, WA (US); Richard Junqiang Qian, Redmond, WA (US)

(73) Assignee: Microsoft Technology Licensing, LLC, Redmond, WA (US)

(21) Appl. No.: 15/801,193

(22) Filed: Nov. 1, 2017

(51) Int. Cl. G06F 17/30; G06F 3/0481; G06F 3/0482

(52) U.S. Cl. CPC G06F 17/30867; G06F 3/0482; G06F 3/04817; G06F 17/30398

(57) ABSTRACT

Maintaining search context within a series of searches while preserving screen real estate on a computing device leads to improvements in the functionality of those computing devices and improves the user experience thereon. A helical navigation structure allows users to navigate back and forth in a search session to maintain a prior search's context to keep searches consistent while refining the search without sacrificing real estate on the display device or having to start new search sessions. New categories or subcategories that the user can explore replace search elements that handle less-refined search levels, and when a search element associated with a content item is selected, the user is provided a new interface to choose whether to explore that content or continue refining the search.

### BACKGROUND

When using a search engine, each query requires computing resources to be expended to provide sets of results for that query. As users explore a topic, searches may be expanded, refined, or changed, which requires more resources to be expended to provide those results as each query changes how the search engine views the context of the search. In addition to using significant computing resources, this often leaves users frustrated with the inability of the search engine to produce tailored results.

### SUMMARY

This summary is provided to introduce a selection of concepts in a simplified form that are further described below in the Detailed Description section. This summary is not intended to identify all key or essential features of the claimed subject matter, nor is it intended as an aid in determining the scope of the claimed subject matter.

A helix search interface is provided herein to reduce user frustration in the search process and to reduce the computing resources expended in providing relevant search results to the user in the course of a series of searches (i.e., a search series). Users are provided with search elements that may be combined with text queries to refine, expand, or shift their searches while maintaining the context of prior searches in a search series.

The helix search interface provides a search experience that tailors itself to the user's search patterns. A blank canvas is often the most difficult place to start; the user has to know how to ask a given question and may not know how to refine the query. By providing suggested topics/areas and sub-intents within these topics, the helix search interface jump-starts the user into browsing for things in way that the user might not have known how to ask, and with fewer mis-steps in the querying processes; reducing the number of non-responsive queries made in a string of searches and thus saving computing resources and bandwidth.

Additionally, small form factors such as mobile devices are difficult to type into—while this is still supported, the helix search interface provides a simple alternate way to find search results without having to type. Results expand from a prior search user interface element. The results are presented as icons to represent categories in which further search may be possible as well as cards representing the results for the search. As users select the result elements, the helix search interface is updated to show new search results (including further categories and direct results) that are based on a selected result element and that expand from the selected result element. As more results are returned, older result elements are removed from display within the helix user interface and new elements are presented for display.

The users may navigate forward in a search series, as described above, until card-producing results are selected and presented for display, the users quit the search process, or the users select a central element, in which case the search process navigates backwards. When navigating backwards, the last selection of a result element is “undone” and the user interface is reverted to show the previously presented user interface; allowing users to reformulate their searches without having to change the context leading up to that point in the search.

Examples are implemented as a computer process, a computing system, or as an article of manufacture such as a device, computer program product, or computer readable medium. According to an aspect, the computer program product is a computer storage medium readable by a computer system and encoding a computer program comprising instructions for executing a computer process.

The details of one or more aspects are set forth in the accompanying drawings and description below. Other features and advantages will be apparent from a reading of the following detailed description and a review of the associated drawings. It is to be understood that the following detailed description is explanatory only and is not restrictive of the claims.

### BRIEF DESCRIPTION OF THE DRAWINGS

The accompanying drawings, which are incorporated in and constitute a part of this disclosure, illustrate various aspects. In the drawings:

FIG. 1 illustrates an example operating environment which the present disclosure may be practiced;

FIGS. 2A-F illustrate various example user interfaces that are used in providing a helix search interface as described in the present disclosure;

FIGS. 3A-C illustrate various example user interfaces of content cards provided in conjunction with a helix search interface as described in the present disclosure;

FIG. 4 is a flow chart showing general stages involved in an example method for providing a helix search interface;

FIG. 5 is a block diagram illustrating example physical components of a computing device;

FIGS. 6A and 6B are block diagrams of a mobile computing device; and

FIG. 7 is a block diagram of a distributed computing system.

### DETAILED DESCRIPTION

The following detailed description refers to the accompanying drawings. Wherever possible, the same reference numbers are used in the drawings and the following description refers to the same or similar elements. While examples may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description is not limiting, but instead, the proper scope is defined by the appended claims. Examples may take the form of a hardware implementation, or an entirely software implementation, or an implementation combining software and hardware aspects. The following detailed description is, therefore, not to be taken in a limiting sense.

A helix search interface is provided herein to reduce user frustration in the search process and to reduce the computing resources expended in providing relevant search results to the user in the course of a series of searches (i.e., a search series). Users are provided with search elements that may be combined with text queries to refine, expand, or shift their searches while maintaining the context of prior searches in a search series.

The helix search interface provides a search experience that tailors itself to the user's search patterns. A blank canvas is often the most difficult place to start; the user has to know how to ask a given question and may not know how to refine the query. By providing suggested topics/areas and sub-intents within these topics, the helix search interface jump-starts the user into browsing for things in way that the user might not have known how to ask, and with fewer mis-steps in the querying processes; reducing the number of non-responsive queries made in a string of searches and thus saving computing resources and bandwidth.

Additionally, small form factors such as mobile devices are difficult to type into—while this is still supported, the helix search interface provides a simple alternate way to find search results without having to type. Results expand from a prior search user interface element. The results are presented as icons to represent categories in which further search may be possible as well as cards representing the results for the search. As users select the result elements, the helix search interface is updated to show new search results (including further categories and direct results) that are based on a selected result element and that expand from the selected result element. As more results are returned, older result elements are removed from display within the helix user interface and new elements are presented for display.

The users may navigate forward in a search series, as described above, until card-producing results are selected and presented for display, the users quit the search process, or the users select a central element, in which case the search process navigates backwards. When navigating backwards, the last selection of a result element is “undone” and the user interface is reverted to show the previously presented user interface; allowing users to reformulate their searches without having to change the context leading up to that point in the search.

The helix search interface tailors categories presented in the search series based on the user's prior search patterns. An initial request for the helix search interface may be populated with categories that are deemed of global or regional interest, but as the user selects (or does not select) various categories, the position in which those categories are listed will change and the level of search refinement at which they are displayed will also change. For example, if a user is identified as being uninterested in searches related to an “International News” category initially presented, it may be replaced with another category, such as “Weather”, “Local News”, or a frequently-accessed sub-category from a lower level of search refinement (e.g., a given sport sub-category from the “Sports” category) that is promoted “upward” into a particular level of search refinement.

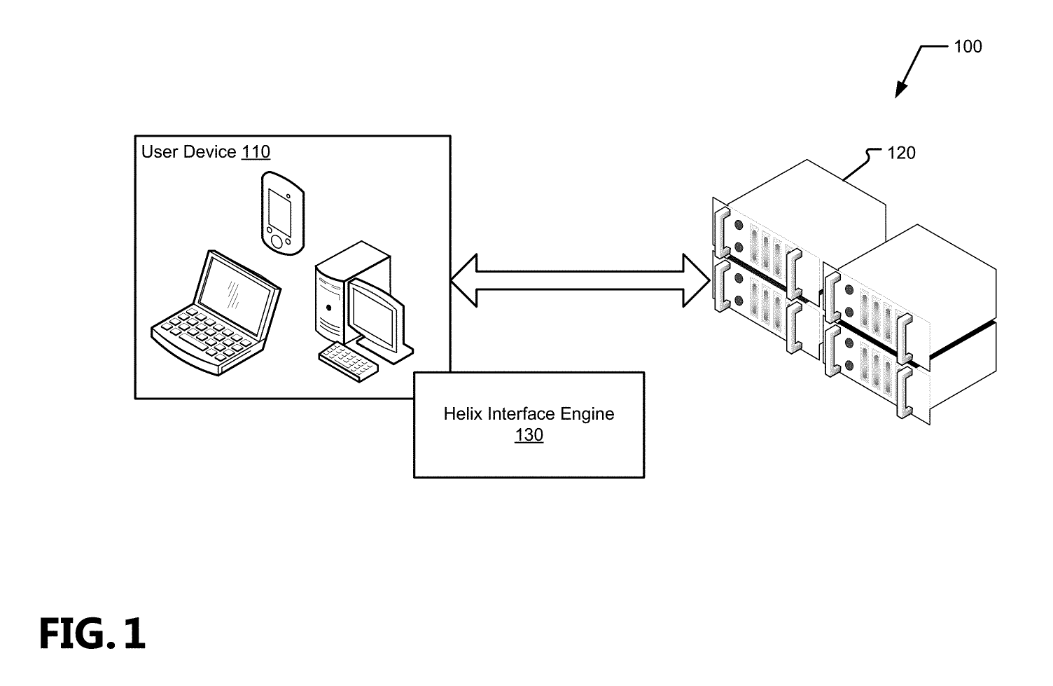

FIG. 1 illustrates an example operating environment 100 in which the present disclosure may be practiced. As illustrated, a user device 110 is in communication with a search engine server 120. The user device 110 transmits one or more queries as part of a search series to the search engine server 120 and receives back from the search engine server 120 various results for the queries. In various aspects, the results include content responsive to a query, categories for further search responsive to a query, recommendations related to a query, pre-populated user interface elements related to the query, and the like. These results are organized for display on the user device 110 via the helix interface engine 130, which is a program, module, or application run on either the user device 110 or the search engine server 120 (e.g., as part of a search engine provided thereby) to produce a navigable exploration experience for users that maintains context throughout a series of searches.

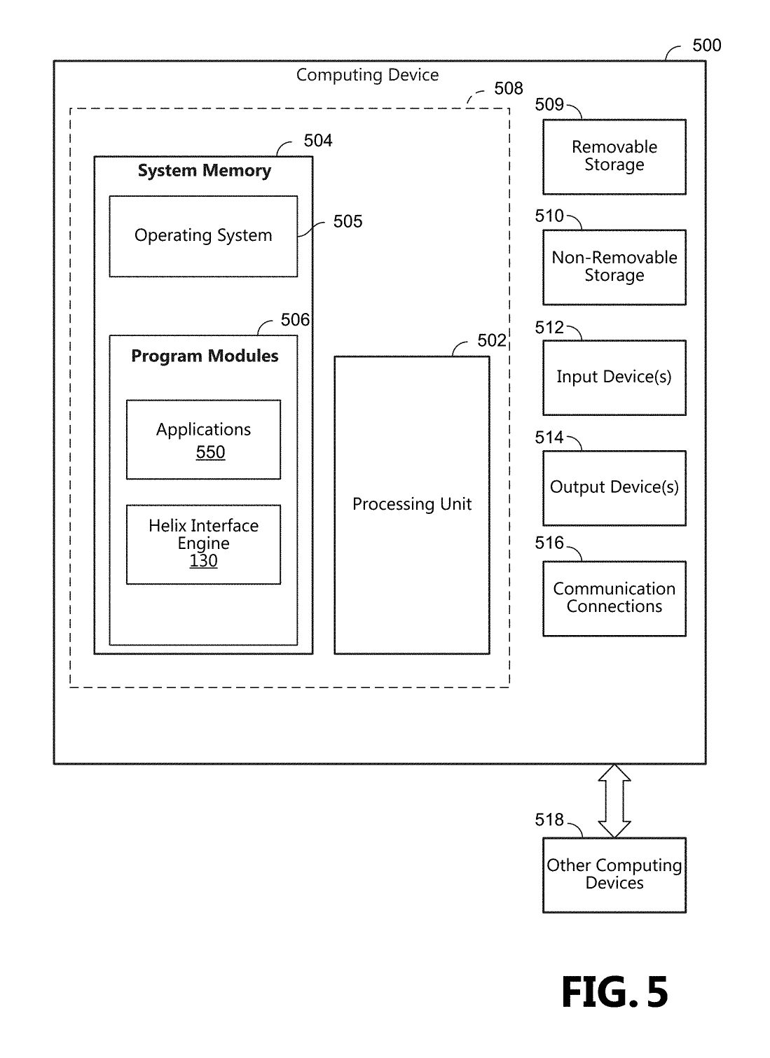

The user device 110 and the search engine server 120 are illustrative of a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, printers, and mainframe computers. The hardware of these computing systems is discussed in greater detail in regard to FIGS. 5-7.

While the user device 110 and the search engine server 120 are shown remotely from one another for illustrative purposes, it should be noted that several configurations of one or more of these devices hosted locally to another illustrated device are possible, and each illustrated device may represent multiple instances of that device. Various servers and intermediaries familiar to those of ordinary skill in the art may lie between the component systems illustrated in FIG. 1 to route the communications between those systems, which are not illustrated so as not to distract from the novel aspects of the present disclosure.

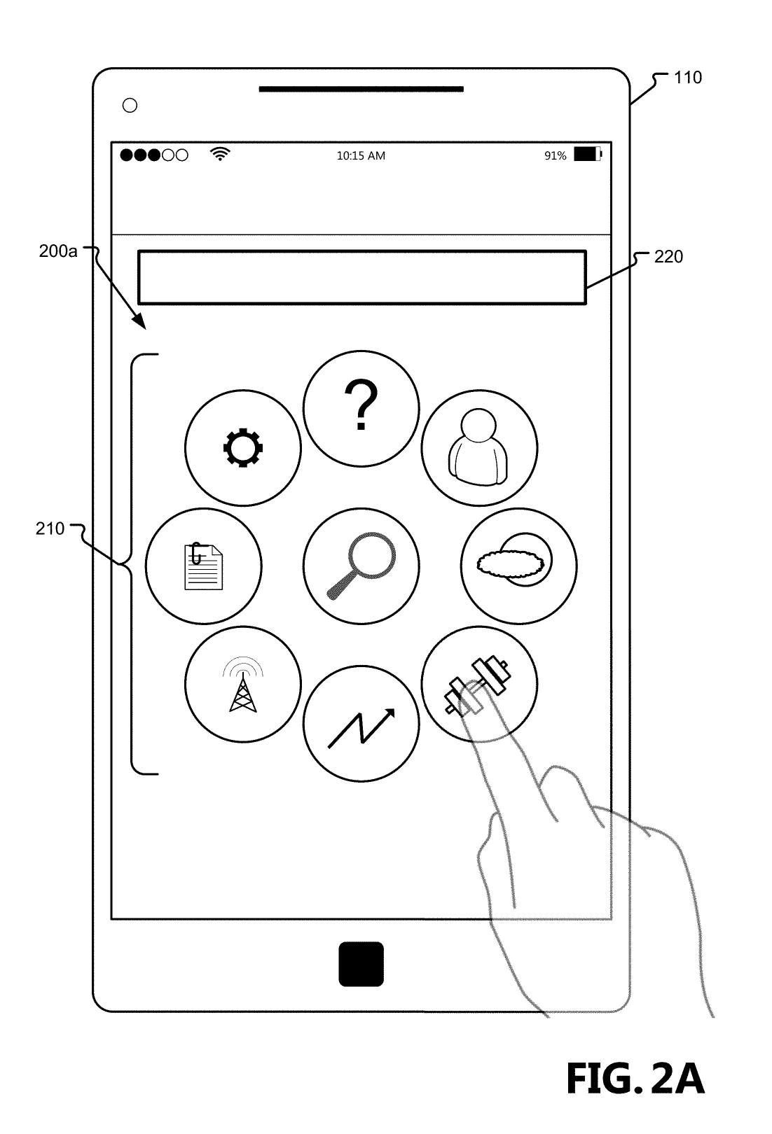

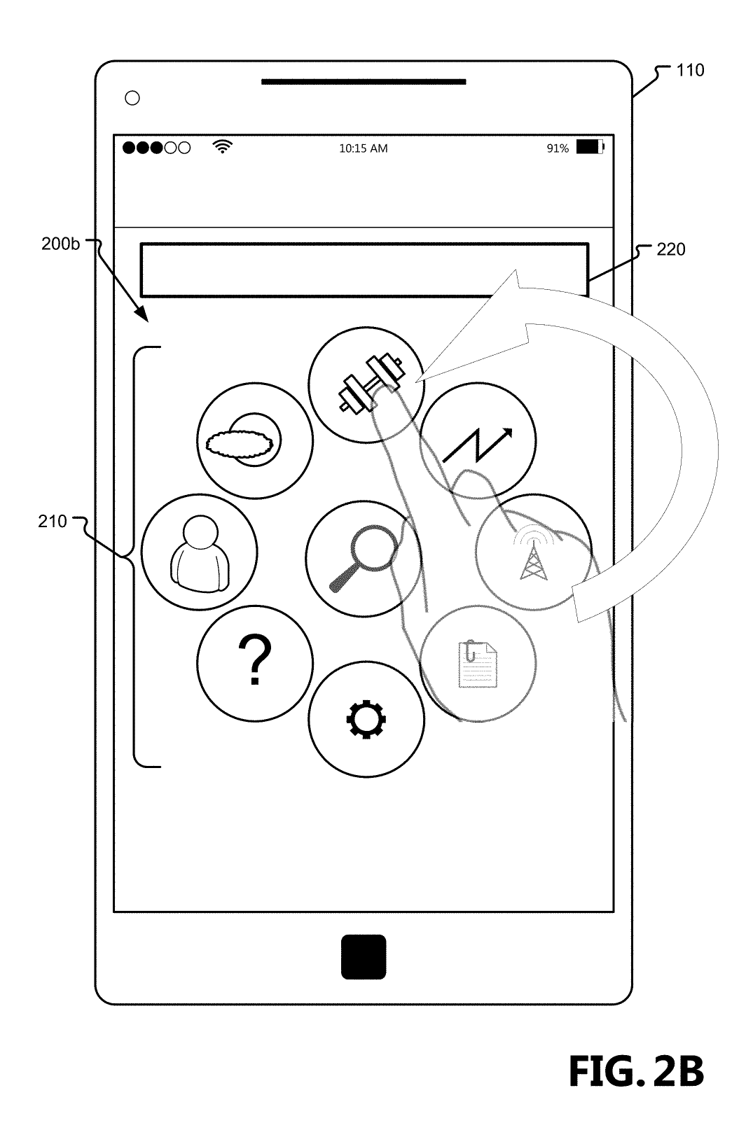

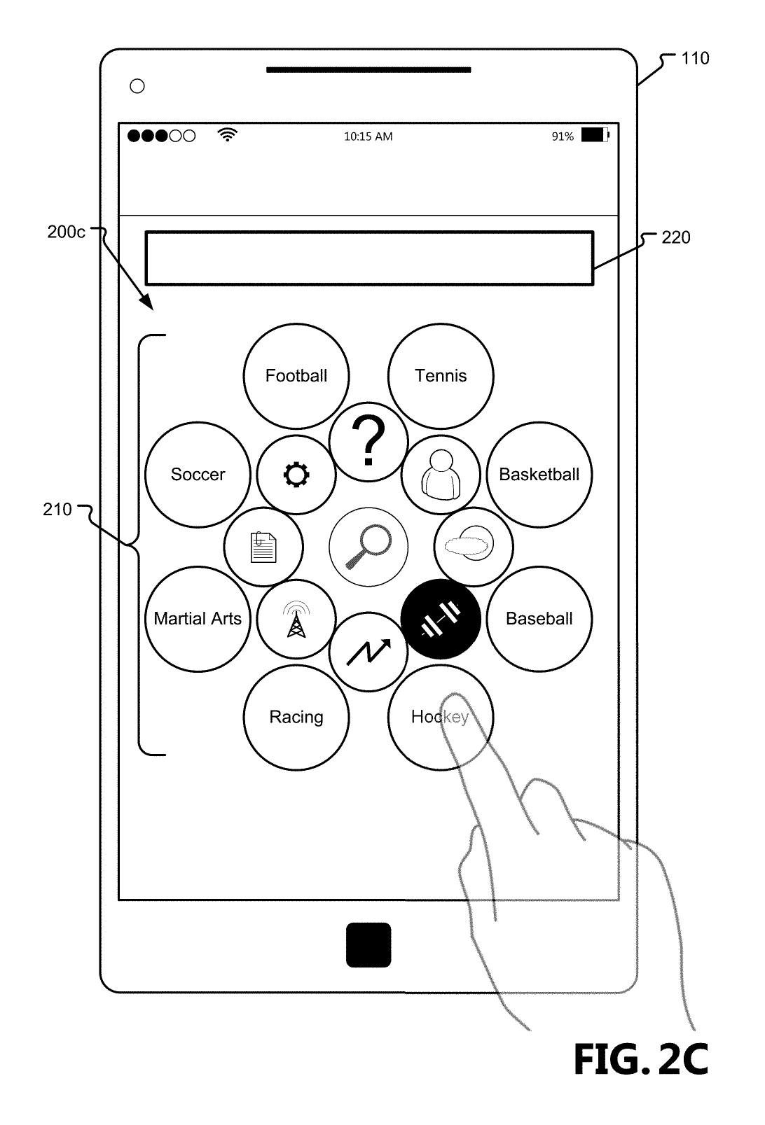

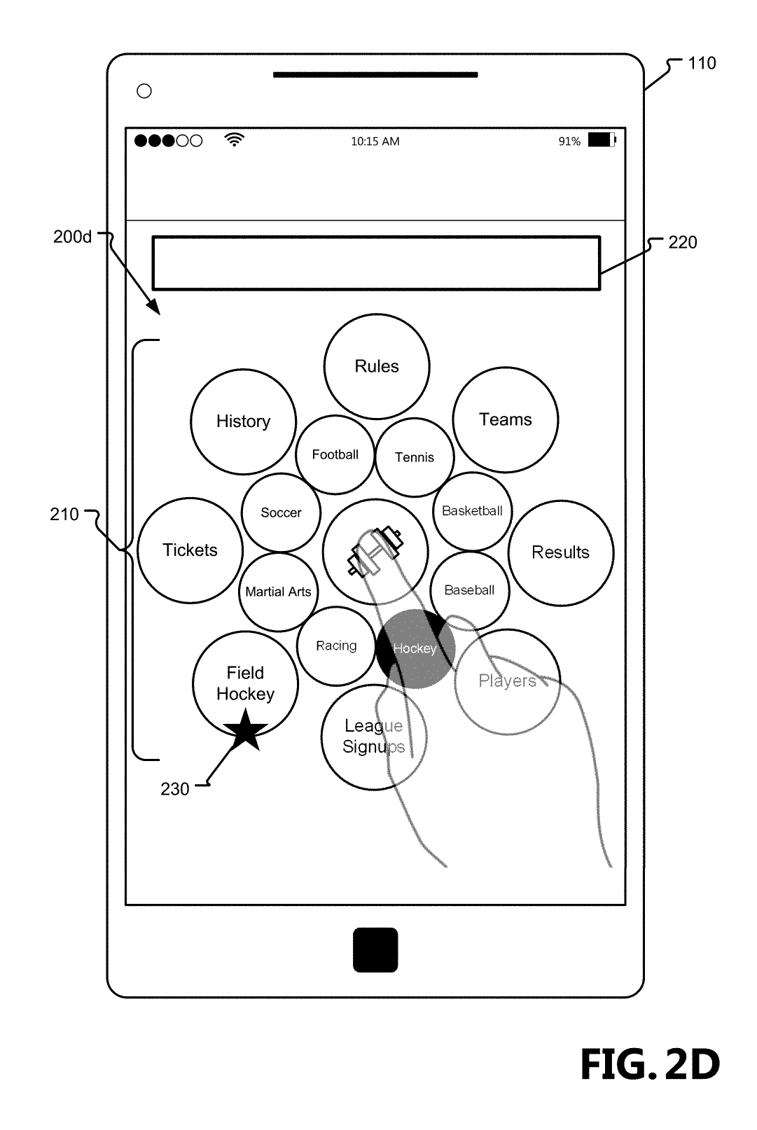

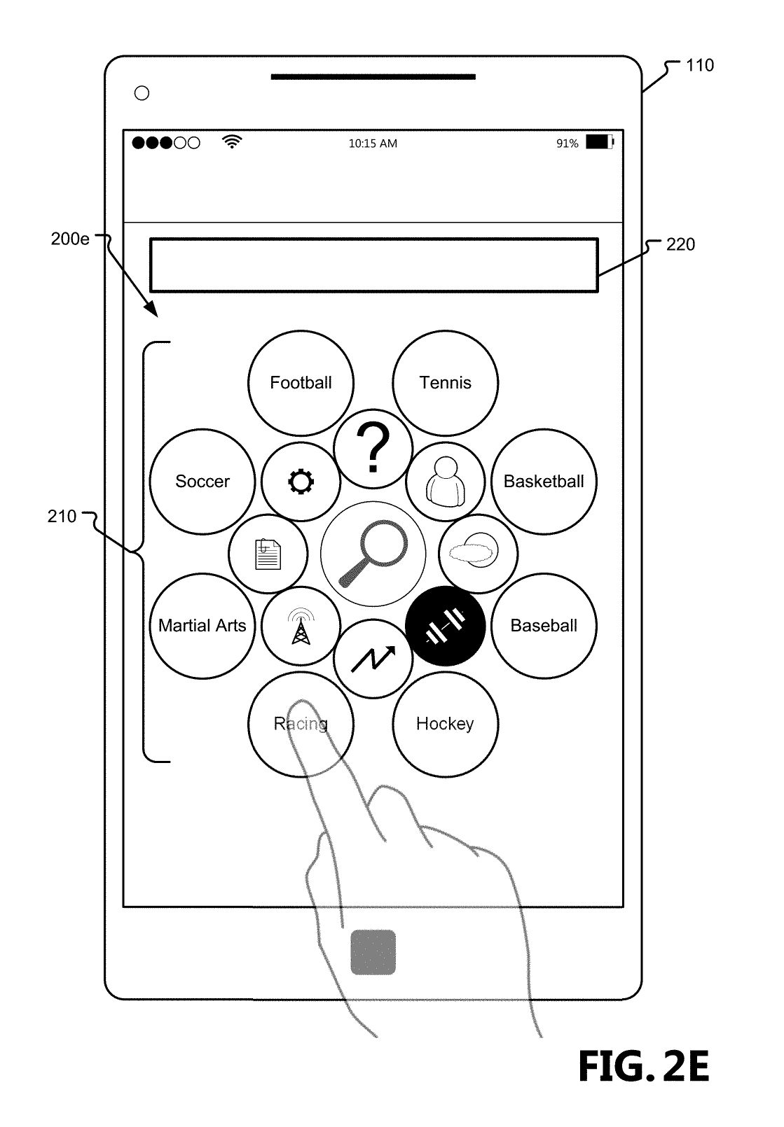

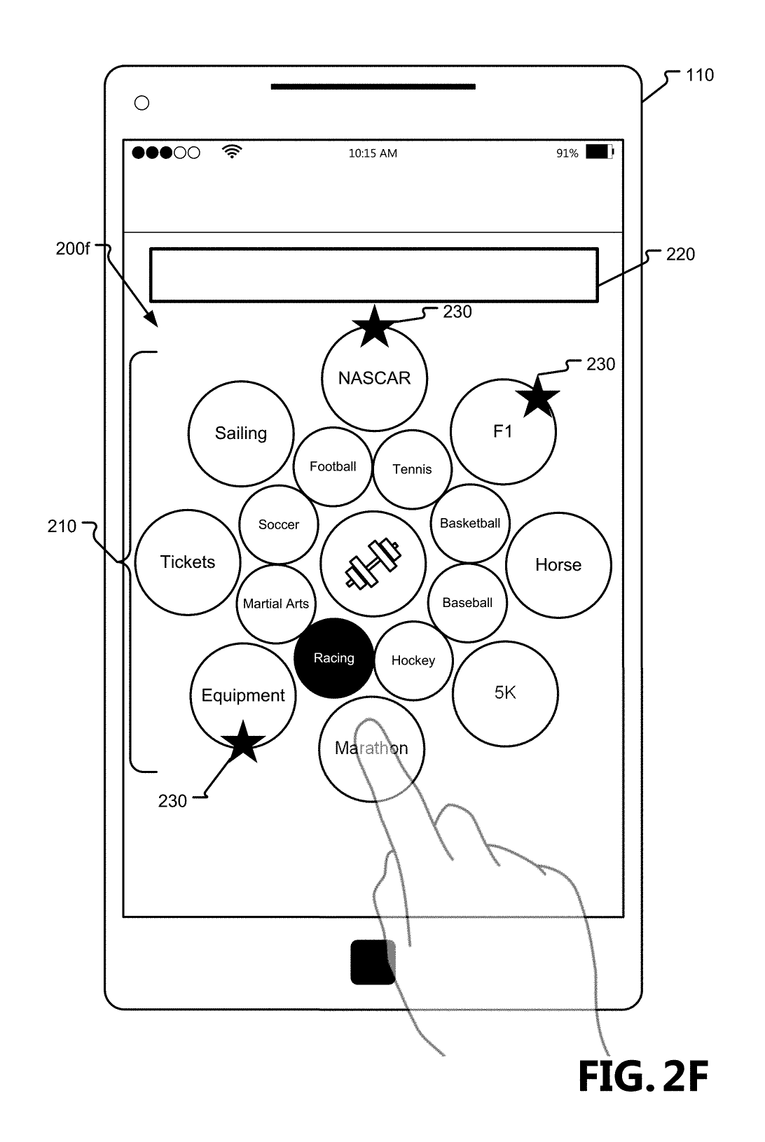

FIGS. 2A-F illustrate various example search user interfaces 200a-f (generally referred to as search UI 200) that are used in providing a helix search interface as described in the present disclosure. The search UI 200 are shown on a user device 110 that is illustrated as a touch-enabled mobile device (such as a tablet or smart phone) and commands are generally discussed in relation to touch-commands; however, one of ordinary skill in the art will appreciate that other user devices 110 may also display the search UI 200 discussed herein and may use voice commands, mice/keyboard inputs, spatial recognition commands, or simulated commands driven by a “bot” instead of the touch commands generally recited herein without departing from the spirit of the present disclosure. In the examples given in FIGS. 2A-F, the presentation of elements is based on selections made by a hypothetical user in an earlier-presented and discussed search UI 200. As will be further appreciated, the individual elements shown in FIGS. 2A-F are given as non-limiting examples; although various text and/or glyphs are shown, glyphs may be changed or substituted for text and text may be changed or substituted for glyphs in other aspects.

FIG. 2A illustrates a first search UI 200a that is displayed in response to a request for search functionality on the user device 110. Several search elements 210 are illustrated in each of FIGS. 2A-F that are associated with different levels of search refinement, and are displayed based on their level of search refinement. Also illustrated is a text entry box 220 that is configured to receive text input to define query parameters. In various aspects, the text entry box 220 may be omitted or not displayed until a search element 210 is selected or keyboard or voice input is detected. In other aspects, the search element 210 shown in the center of the first search UI 200a may be configured to receive text input as a text entry box 220, and the rectangular text entry box 220 shown in FIG. 2A may be omitted or mirror the contents in the central search element 210.

Of the plurality of search elements 210 displayed in FIG. 2A, one search element 210, associated with a keyword search and shown with a magnifying glass icon, belongs to a first level of search refinement, that (when selected) will query a search engine with any text received in the text entry box 220. Search elements 210 are displayed according to their level of search refinement in the context of the search series. For example, search elements 210 may be illustrated as a tree of icons, where child search elements 210 of a higher search refinement level are shown depending from their parent search elements 210 of the immediately lower search refinement level.

In the illustrated example, the remaining search elements 210 are displayed concentrically around the one search element 210 and belong to a second level of search refinement that represent various categories by which the search engine may be queried. From the top, and described in clockwise order, search elements 210 having a question mark icon, a person icon, a weather icon, a dumbbell icon, a graph icon, a radio icon, a document icon, and a gear icon are displayed in a location surrounding the one search element 210 illustrated with the magnifying glass icon. As additional levels of search refinement are determined based on user selection of the search elements 210, search elements 210 associated with higher levels of search refinement will be added to the user interface 200 to maintain the context of the search series, such as in FIGS. 2C-F.

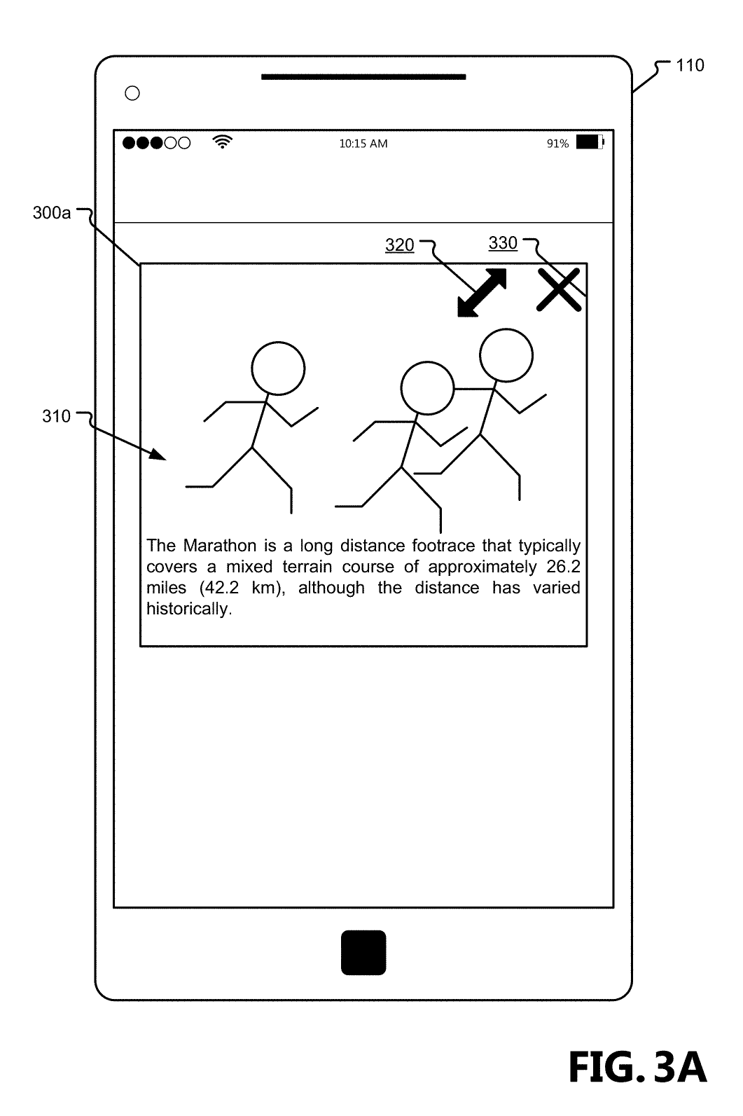

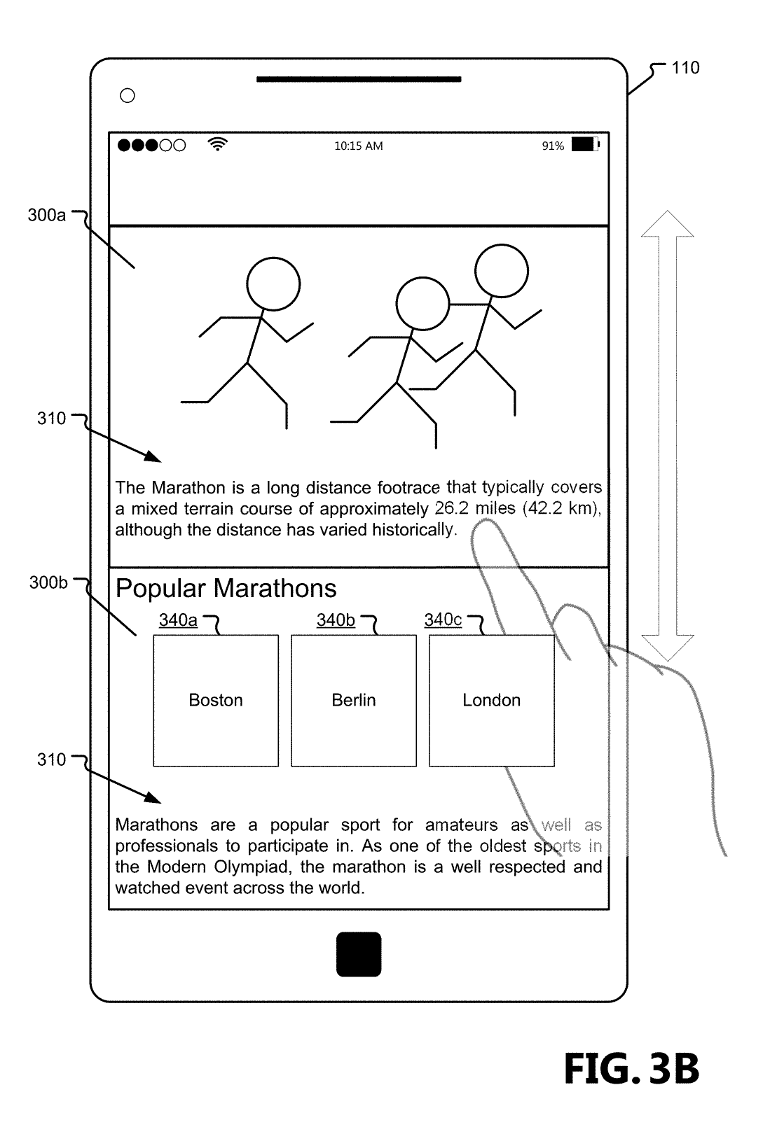

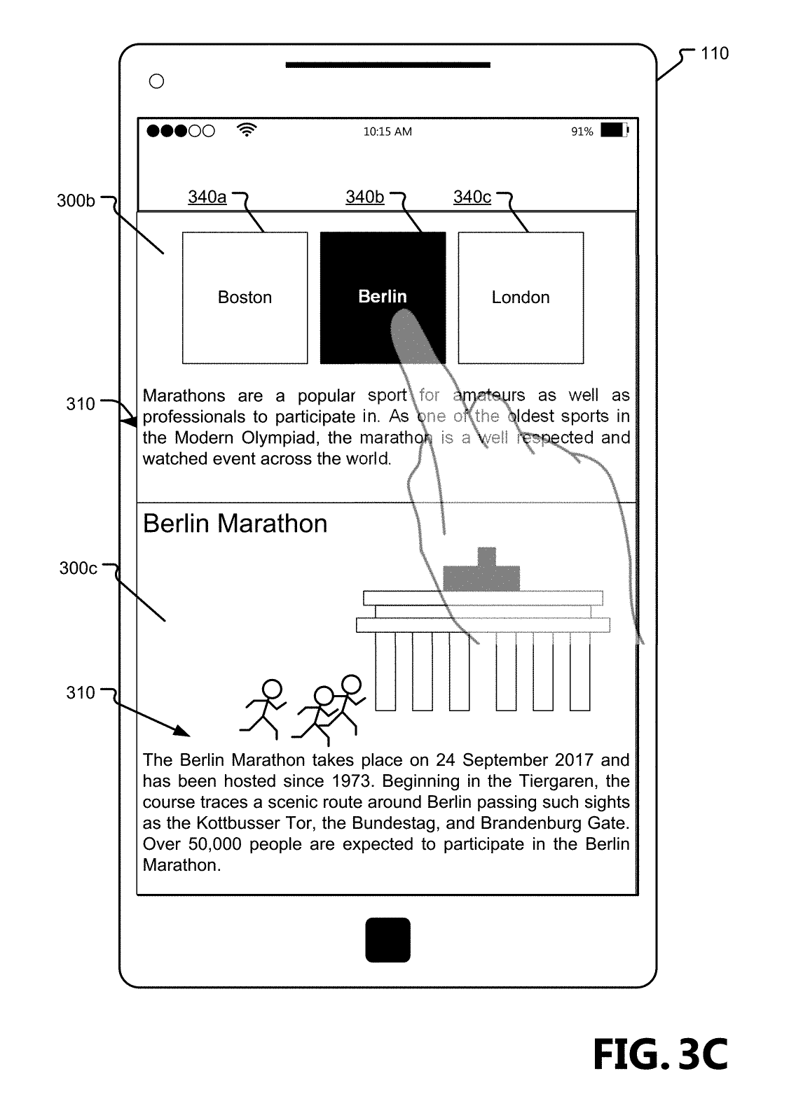

Each search element 210 belonging to the second or higher level of search refinement is associated with a distinct category that can be used with or independently of any text in the text entry box 220 to query the search engine. For example, the search element 210 illustrated with the gear icon may be related to a “products” category, whereas the search element 210 illustrated with the dumbbell icon may be related to a “sports” category. When a user selects a search element 210, the search engine is queried according to the category associated with the search element 210 (and any text in the text entry box 220) and one or more results are returned to the user device 110. In various aspects, the results include categorized results and uncategorized results. As used herein, categorized results refer to results that have additional subcategories and content for a user to explore, such as is shown in FIGS. 2B-F, and uncategorized results refer to results that are associated with content that can be presented to the user as is shown in FIGS. 3A-C.

In various aspects, the search engine may return all of the results to the user device 110 to determine whether the results include distinct subcategories, and how to organize those subcategories, or the search engine may determine and return the subcategories as the categorized results to the user device 110. Results may be grouped into categories (or left uncategorized) based on similar keywords, number of results, similar hosts for the results, “freshness” of a topic that is new or trending, etc. As user search patterns are learned, the categories into which results are grouped may be adjusted and certain categories included or excluded from the categorized results. Search elements 210 associated with search categories belonging to a second level of search refinement that are presented initially in response to a request for a search UI 200 may be based on previous user searches, pre-defined categories set on the user device 110, or by the search engine based on text included in the text entry box 220.

For example, when tailoring the categories based on the user's search patterns, the historically unused categories may be demoted from a higher level of search refinement to a lower level, and be replaced with other categories based on global, local, or user-historic interest. For example, a search element 210 for “Celebrity News” may go unselected by a user for a predetermined number of searches, and may be removed from the search UI 200. In various aspects, the removal of the search element 210 for “Celebrity News” may cause the remaining search elements 210 to be re-organized or re-distributed for display in the search UI 200. In other aspects, the removal of the search element 210 for “Celebrity News” may cause another category to be substituted for “Celebrity News”, in the search element 210, such as, a frequently accessed sub-category. For example, if the user consistently selects a “Sports” category and then selects an “NFL” sub-category thereof, then the “NFL” sub-category maybe promoted to replace the unused category of “Celebrity News”.

The text entry box 220 is an optional element of the search UI 200; a user may explore content and navigate a search series with or without entering text for submission to the search engine server 120 and its hosted search engine. For example, the group of search elements 210 that belong to the second level of search refinement may be provided as starting points for searches on trending or popular topics that the search engine server 120 has identified from other users over a period of time. In another example, further illustrating the foregoing examples, a user who selects a search element 210 associated with products and has input “Acme” in the text entry box 220 may be provided search results related to the products offered by Acme Incorporated, whereas a user who selects the search element 210 associated with products without text in the text entry box 220 may be provided with search results related to products offered by several companies (including or excluding those from Acme Incorporated) that have been noted as being popular searches within the last d days or h hours.

FIG. 2B illustrates a second search UI 200b that is displayed in response to a user gesture of the search elements 210 that belong to the second level of search refinement. For example, a select-and-rotate gesture is used to rearrange the search elements 210 so that the sports search element 210 is now displayed above the search element 210 of the first level of search refinement. In various aspects, selection of a search element 210 associated with a keyword search (e.g., the search element 210 illustrated with the magnifying glass icon) will result in a keyword search that incorporates any text entered in the text entry box 220 and the category of uppermost search element 210 of the higher level of search refinement. As will be appreciated, the search UI 200 may be configured to position a second search element 210 to affect a keyword search in various other positions in addition to or instead of “above” a first search element 210 associated with keyword searching.

In aspects where the keyword search element 210 is affected by an actively positioned second search element 210, a blank space or a search element 210 associated with a “null” category may be displayed in association with the other search elements 210 so that the user may select to perform a keyword search without applying a category to affect a text query or the results returned.

In some aspects, when the user selects a search element 210 associated with a category (e.g., via a tap gesture) instead of positioning that search element 210 into a position to affect a keyword search element 210 and selecting the keyword search element 210, any text in the text entry box 220 will be ignored, and results that are trending or popular for the selected category will be returned.

FIG. 2C illustrates a third search UI 200c that is displayed in response to user selection of the search element 210 that is associated with a sports category and is shown with the dumbbell icon in FIGS. 2A-F. As shown, several categorized results associated with the sports category are returned by the search engine and shown as search elements 210 belonging to a third level of search refinement. The example categories associated with each third-level search element 210 (from top-right, clockwise) are shown as “Tennis”, “Basketball”, “Hockey”, “Racing”, “Martial Arts”, “Soccer”, and “Football”.

The order, position, and composition of the third-level search elements 210 may be based on a global or regional popularity of the subcategories of the selected send-level search refinement category (in this example, sports) or a learned pattern of searching for the specific user. For example, based on the greater popularity of baseball-related searches compared to tennis-related searches in the user's region, the search element 210 associated with baseball is presented closer to the search element 210 for sports, to improve the user experience and efficiency in navigating the search series. Continuing the example, the search element 210 associated with hockey may also be presented in proximity to the sports search element 210 based on the user's prior search history for hockey-related items regardless of whether hockey is popular in the region in which the user is located.

FIG. 2D illustrates a fourth search UI 200d that is displayed in response to user selection of the search element 210 that is associated with a hockey category and is shown with the text “hockey” in FIGS. 2C-F. Several pieces of content and additional categories of further search may be returned by the search engine, and are presented as search elements 210 belonging to a fourth level of search refinement in the fourth search UI 200d.

Depending on the amount of screen real estate allocated for the search UI 200 on the user device 110, it may not be possible to display all of search elements 210. Therefore when the search elements 210 exceed the available display space, the search elements 210 are helically shifted for display, such that the search element 210 of the lowest level of search refinement currently displayed is removed from display and the search elements 210 of the next-highest currently-displayed level of search refinement are also removed from display, except for the actively selected search element 210 of that level, which is displayed in the location vacated by the lowest level search element 210. The other search elements 210 are reposition to occupy the vacated location of the search elements 210 of the next-lower level of search refinement until the search elements 210 belonging to the highest level of search refinement can be displayed on the user device 110.

In the illustrated example: the sports search element 210 has replaced the keyword search element 210; the search elements 210 belonging to the third level of search refinement (“tennis”, “basketball”, “baseball”, etc.) have replaced the search elements 210 belonging to the second level of search refinement (“sports”, “finance”, “products”, etc.); and the search elements 210 belonging to the fourth level of search refinement (“Rules”, “Teams”, “Results”, etc.) have replaced the search elements 210 belonging to the third level of search refinement (“tennis”, “basketball”, “baseball”, etc.).

Also illustrated in FIG. 2D is an informational icon 230 that is associated with a search element 210 (the “Field Hockey” search element 210 in the illustrated example). Although shown as a star in FIG. 2D, an informational icon 230 may be presented as a differently shaped icon, as a border effect, a different color, a different shape, a different size, or an animation effect applied an associated search element 210. In various aspects, an informational icon 230 is applied to a search element 210 that will provide categorized results when selected, while in other aspects, an informational icon 230 is applied to a search element 210 that will provide uncategorized results, such as the content cards (300) discussed in regard to FIGS. 3A-C. In the illustrated example, the “Field Hockey” search element 210 is illustrated with an associated informational icon 230 indicating that if the user were to select it, additional categorized results related to field hockey would be provided to the user to explore (e.g., the rules, history, teams, etc.); the other search elements 210 will provide uncategorized results if selected. If the user frequently selects the “Field Hockey” search element 210, it may be promoted to be a peer with the “Hockey” search element 210 (which may be renamed to “Ice Hockey”) or be promoted over the “Hockey” search element 210 to be a peer with the “Sports” search element 210. As will be appreciated, the display of further categorized results may induce a subsequent helical shift so that the search elements 210 belonging to the fifth level of search refinement (e.g., subcategories of field hockey) may be displayed on the user device 110.

In addition or instead of helically shifting the search elements 210 to provide additional display space for the new search elements 210, the existing search elements 210 may be reduced in size compared to their earlier display. For example, the search elements 210 belonging to the first and second levels of search refinement are shown at a first size in FIGS. 2A and 2B, but are shown in a second, smaller, size in FIG. 2C in response to including the search elements 210 belonging to the third level of search refinement for display. As shown in FIG. 2D, the reduced size may be limited to only one level of search refinement, or to multiple levels, as is shown in FIG. 2C. User preferences, minimum font/icon sizes, length of any text included in text-based search elements 210, screen resolution, and the number of search elements 210 may affect which search elements 210 may be resized and how much the area of a given search element 210 may be reduced.

The helical shift of search elements 210 displayed on the user device 110 provides an improvement to the computing device providing the user interface as well as addressing the computer-centric problem of how to display data in a limited space. The users interfaces described herein are directed to addressing at least this problem by removing the oldest elements of the search series from display, but allowing navigation back to those elements to refine or redefine the search series, thus freeing up display area for the presentation of additional information in an easily navigable format.

FIG. 2E illustrates a fifth search UI 200e, similar to the second search UI 200b, that is displayed in response to user selection in FIG. 2D of the search element 210 that is associated with a sports category and is shown with the dumbbell icon in FIGS. 2A-F. In FIG. 2E, the user is shown selecting a different search element 210 than the search element 210 selected in FIG. 2C, wherein the selected search element 210 in FIG. 2E is associated with a racing category that is shown with the text “racing” in FIGS. 2C-F.

FIG. 2F illustrates a sixth search UI 200f that is displayed in response to user selection of the search element 210 that is associated with a racing category and is shown with the text “racing” in FIGS. 2C-F. The selected search element 210 is used, in conjunction with any text present in the text entry box 220, to query the search engine to provide subcategories and uncategorized content that the user may further explore. In the illustrated example, search elements 210 are presented with categories and content belonging to a fourth level of search refinement of (clockwise from the top position) “NASCAR”, “F1”, “Horse”, “5K”, “Marathon”, “Equipment”, “Tickets”, and “Sailing”. The search elements 210 belonging to the fourth level of search refinement are associated with subcategories related to the selected search element 210 belonging to the third level of search refinement; in this example, the “racing” search element 210.

As will be noted, both FIG. 2D and FIG. 2F both include a search element 210 that belongs to the fourth level of search refinement shown as “Tickets”; however, these search elements 210 are different, as the “Tickets” search element 210 of the fourth user interface 200d is related to “Hockey” (e.g., tickets to hockey games) and the “Tickets” search element 210 of the sixth user interface 200f is related to “Racing” (e.g., tickets to races).

Additionally, the search elements 210 associated with “NASCAR”, “F1”, and “Equipment” are presented with associated informational icons 230, that indicate that if the user were to select those search elements 210, additional categorized results would be presented to the user for exploration. As will be appreciated, in other aspects the search elements 210 associated with “Horse”, “5K”, “Marathon”, “Tickets”, and “Sailing” may be associated with informational icons 230 (in addition to or instead of the search elements 210 associated with “NASCAR”, “F1”, and “Equipment”) to indicate that if the user were to select those search elements 210, uncategorized results would be presented to the user for exploration, as is discussed in regard to FIGS. 3A-C.

Although the examples given in relation to FIGS. 2A-F are given with four levels of search refinement, one of ordinary skill in the art will appreciated that more or fewer levels of search refinement may be used in different aspects. Similarly, although particular shapes, colors, categories, subcategories, and icons are used in the examples given in FIGS. 2A-F, different aspects are envisioned that use different shapes, colors, categories, subcategories, and icons when maintaining search context across a series of searches according to the present disclosure.

FIGS. 3A-C illustrate various example user interfaces of content cards 300 provided in conjunction with a helix search interface as described in the present disclosure on a user device 110. In the examples given in FIGS. 3A-C, the content cards 300 are based on previous selections made in the search UI 200, (specifically the marathon search element 210 from FIG. 2F) and in earlier-presented content cards 300.

FIG. 3A illustrates a first content card 300a providing an initial presentation of uncategorized content related to marathons, as selected earlier in an example search UI 200. The first content card 300a includes various results content 310 returned from the search engine server 120 to the user device 110 such as images, videos, sound files, document files, hyperlinks, and text.

The first content card 300a also includes an explore control 320 and a dismiss control 330 that, when selected by the user, will respectively signal the helix interface engine 130 to further explore the uncategorized content or dismiss the first content card 300a and return to the search UI 200 that produced the first content card 300a (in the given example, sixth search UI 200f, presented in FIG. 2F). When a user selects to continue exploring the uncategorized content, additional content cards 300 will be displayed related to the results returned to the user device 110, as is discussed in greater detail in regard to FIGS. 3B and 3C.

In various aspects, the user may submit commands via gesture or voice to explore or dismiss the content card 300. For example, a user may “swipe” left or right to dismiss the content card 300, or a user may “swipe” up or down to explore the uncategorized content in new and previously presented content cards 300.

FIG. 3B illustrates a user exploring the uncategorized content further, showing some of the first content card 300a and a new, second content card 300b displaying additional results content 310. In various aspects, a user may navigate via touch controlling (dragging up and down), keyboard controls (up and down arrows), a scroll bar, or the like. As will be appreciated, older content cards 300 may be “scrolled” off of the display device of the user device 110, but may be navigated back to via the reverse input used to navigate to new content cards 300 (e.g., scrolling down to see new content cards 300 versus scrolling up to see older content cards 300).

In various aspects, when a user selects to explore the content cards 300, the content cards 300 are displayed in a larger area of the available display space than when first presented to the user to decide whether to explore or dismiss the content cards 300. As illustrated in FIGS. 3A and 3B, the first content card 300a takes up more space horizontally in FIG. 3B than in FIG. 3A once it has been selected for exploration, thus providing more content per unit of vertical space, and allowing other content cards 300 to be displayed more fully in the available display space.

The results content 310 displayed in the second content card 300b is related to the results content 310 displayed in the first content card 300a, and may be selected for display based on a relevancy to the search query, a popularity of the content, a frequency of search for the particular content shown in the content card 300, a sponsorship of the content, or user selection of particular content within an earlier content card 300. For example, under the “popular marathons” content provided in the second content card 300b, three content items 340a-c (collectively, content items 340) are shown for marathons in “Boston,” “Berlin,” and “London,” that the user can select to provide a third content card 300c, as is shown in FIG. 3C, related to specific results content 310 for one of those content items 340.

FIG. 3C illustrates a user continuing to explore the uncategorized content, showing some of the second content card 300b and a new, third content card 300c presenting additional results content 310 based on the user's selection of a content item 340 associated with a hyperlink or exploration option presented in the second content card 300b. As illustrated, the user has selected the second content item 340b associated with “Berlin,” and in response, the third content card 300c is created to present additional results content 310 related to the Berlin marathon. As will be appreciated, the example given in FIG. 3C is non-limiting, and a user may return to the second content card 300b to select a different content item 340 to replace the content presented in the third content card 300c (e.g., with information about the London or Boston marathons). The user may also continue exploring from the third content card 300c, in which case additional results content 310 will be retrieved for presentation on additional content cards 300.

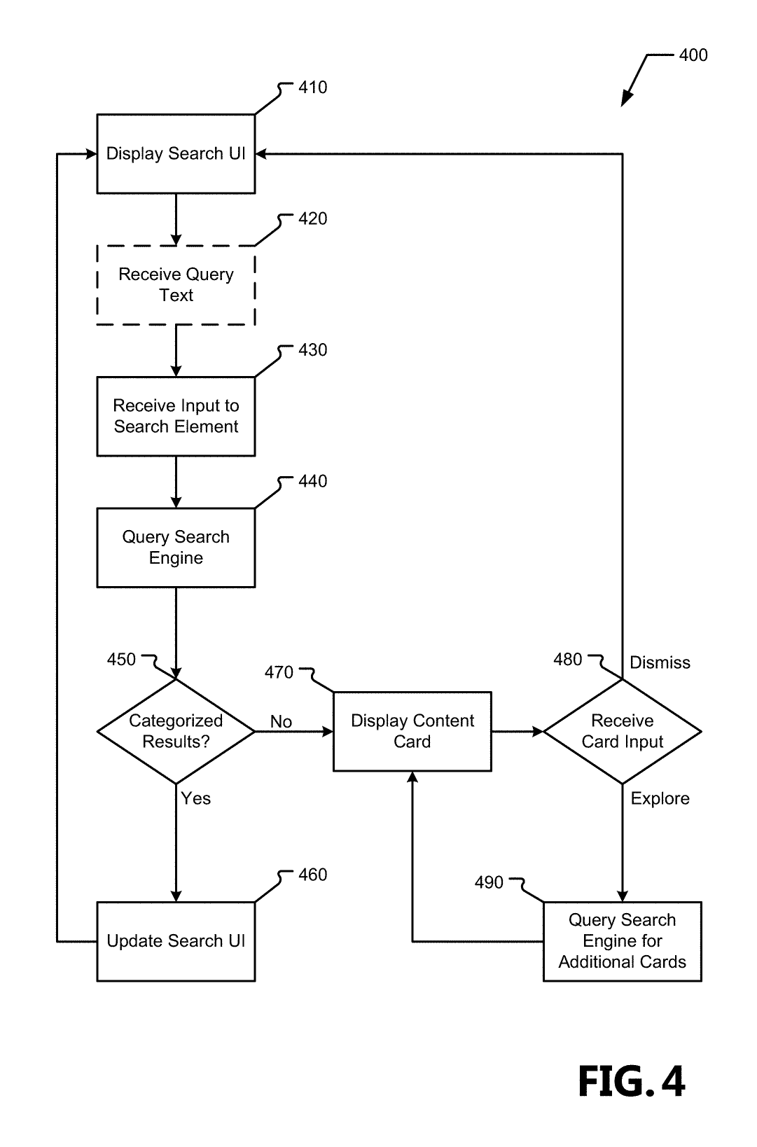

FIG. 4 is a flow chart showing general stages involved in an example method 400 for providing a helix search interface. Method 400 begins at OPERATION 410, where a search UI 200 is displayed. In various aspects, the search UI 200 is displayed in response to a command to provide search functionality on a user device 110 or when a content card 300 is dismissed (returning from DECISION 480). The search UI 200 displayed at OPERATION 410 may be an initial search UI 200, that provides a plurality search elements 210 in a default or initial configuration, or the search UI 200 may be configured to include a plurality of search elements 210 based on the context of the most recently made search series; allowing a user to pick up a search where it was left off or navigate backwards in a search series to redefine the content desired.

At OPTIONAL OPERATION 420, query text is received (e.g., via a text entry box 220) for use in the search interface. In various aspects, the helix search interface can receive and ignore text for a query; receive and use text in a query; or perform a query without receiving text. In some aspects, a user may provide text via manual entry (e.g., a hardware or software keyboard) or via voice entry in conjunction with a speech-to-text application.

Proceeding to OPERATION 430, input to a search element 210 is received. In various aspects, the input is received as a tap, click, double-tap, double-click, press, selection gesture, or the like of an indicated search element 210.

The search engine is queried at OPERATION 440 according to the search element 210 that was selected at OPERATION 430, any previously selected search elements 210 in the search series, and (optionally) any text provided to further refine the query. In various aspects, the search engine is hosted by a search engine server 120 remotely located from the user device 110 and is queried accordingly via a request transmitted via an Internet Protocol (IP) network. In other aspects, the search engine is hosted locally by the user device 110 for searching for documents, programs, and settings local to the user device 110 and the query is handled by an Application Program Interface (API) to interact with the local search engine.

At DECISION 450 it is determined whether the results provided by the search engine to the query submitted at OPERATION 440 are categorized results, resulting in a new, higher level of search refinement to be displayed in the search UI 200, or uncategorized results, resulting in a content card 300 for the uncategorized content being displayed.

In response to determining at DECISION 450 that the results include categorized results, method 400 proceeds to OPERATION 460, where the search UI 200 is updated to display new search elements 210 associated with the categorized results. The categorized results are associated with new search elements 210 in a higher level of search refinement than the search element 210 selected at the prior execution of OPERATION 430. As will be appreciated, if the newly added search elements 210 cannot be displayed concurrently with the previously displayed search elements 210, due to display space limitations or preferences, the display of search elements 210 will be helically shifted, such that search elements 210 in the updated search UI 200 will be displayed in the location occupied by the search elements 210 of the next lower level of search refinement in the non-updated search UI 200. Method 400 then returns to OPERATION 410 where the updated search UI 200 is displayed on the user device 110.

In response to determining at DECISION 450 that the results include uncategorized results, method 400 proceeds to OPERATION 470, where the search UI 200 is removed from the display device of the user device 110 and a content card 300 related to the uncategorized content is displayed.

Method 400 then proceeds to DECISION 480, where input to the content card 300 is received and it is determined whether the input indicates that the user wishes to dismiss the content card 300 or to further explore the uncategorized content. In various aspects, the input includes the selection of controls (e.g., buttons) integrated into the content card 300, physical or virtual controls provided by the user device 110 (e.g., an escape key, a back button, an enter key, a scroll wheel), or gestures (e.g., swipe left/right to dismiss, swipe up/down to explore).

When it is determined at DECISION 480 that the user has signaled to dismiss the content card 300, the content card 300 is removed from display and method 400 returns to OPERATION 410, where the search UI 200 is again displayed. Depending on user settings, a time between initial display of the content card 300 and its dismissal, and whether the uncategorized content was explored prior to dismissing the content card 300, the search UI 200 displayed when returning to OPERATION 410 may be an initial search UI 200 or the search UI 200 as shown prior to displaying the content card(s) 300 for the uncategorized content.

In one example, if the user were shown the sixth search UI 200f prior to selecting to view a content card 300a for marathon information, as shown in content card 300a in FIGS. 2F and 3A, and signaled to dismiss the content card 300a, the search UI 200 displayed would be the sixth search UI 200f. In another example, if the user were shown the sixth search UI 200f prior to selecting to view a content card 300a for marathon information, as shown in content card 300a in FIGS. 2F and 3A, and signaled to explore the content via additional content card 300, the search UI 200 displayed when all of the content cards 300 are dismissed would be the sixth search UI 200f in some aspects, but could be the first search UI 200a in other aspects, depending on user preferences.

When it is determined at DECISION 480 that the user has signaled to further explore the content presented the content card 300, method 400 proceeds to OPERATION 490 where the search engine is queried to provide additional uncategorized content in an additional content card 300. Depending on the input received at DECISION 480, the query to the search engine may be for a next piece of content of the uncategorized content or may be for a specific type of content of the uncategorized content.

For example, a user viewing a content card 300 for Paris, France may be presented with result content 310 comprising a brief overview of the city and several landmarks (e.g., the Eifel Tower, the Louvre, the Champs Elysees). If the user were to signal an exploration of the uncategorized content by scrolling/gesturing for additional content, the search engine may provide an additional content card 300 related to the history of Paris, whereas if the user were to signal an exploration of the uncategorized content by selecting one of the landmarks, an additional content card 300 related to the selected landmark would be provided by the search engine.

Once the search engine has returned additional content in response to the command for additional uncategorized content, method 400 returns to OPERATION 470, where the additional content is displayed as part of a content card 300. Depending on the screen real estate available for displaying content cards 300, the earlier-provided content cards 300 may be scrolled upward, condensed, or removed from display to allow the display of the new content card 300. As will be appreciated, a user may return to a previously displayed content card 300 in a series of content cards 300 by navigating backwards (e.g., scrolling upwards when scrolling downwards provides new content cards 300, selecting condensed content cards 300).

Method 400 may conclude when a user provides a command to dismiss the search functionality.

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 5-7 and the associated descriptions provide a discussion of a variety of operating environments in which examples are practiced. However, the devices and systems illustrated and discussed with respect to FIGS. 5-7 are for purposes of example and illustration and are not limiting of a vast number of computing device configurations that are used for practicing aspects, described herein.

FIG. 5 is a block diagram illustrating physical components (i.e., hardware) of a computing device 500 with which examples of the present disclosure may be practiced. In a basic configuration, the computing device 500 includes at least one processing unit 502 and a system memory 504. According to an aspect, depending on the configuration and type of computing device, the system memory 504 comprises, but is not limited to, volatile storage (e.g., random access memory), non-volatile storage (e.g., read-only memory), flash memory, or any combination of such memories. According to an aspect, the system memory 504 includes an operating system 505 and one or more program modules 506 suitable for running software applications 550. According to an aspect, the system memory 504 includes helix interface engine 130. The operating system 505, for example, is suitable for controlling the operation of the computing device 500. Furthermore, aspects are practiced in conjunction with a graphics library, other operating systems, or any other application program, and are not limited to any particular application or system. This basic configuration is illustrated in FIG. 5 by those components within a dashed line 508. According to an aspect, the computing device 500 has additional features or functionality. For example, according to an aspect, the computing device 500 includes additional data storage devices (removable and/or non-removable) such as, for example, magnetic disks, optical disks, or tape. Such additional storage is illustrated in FIG. 5 by a removable storage device 509 and a non-removable storage device 510.

As stated above, according to an aspect, a number of program modules and data files are stored in the system memory 504. While executing on the processing unit 502, the program modules 506 (e.g., helix interface engine 130) perform processes including, but not limited to, one or more of the stages of the method 400 illustrated in FIG. 4. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, the computing device 500 has one or more input device(s) 512 such as a keyboard, a mouse, a pen, a sound input device, a touch input device, etc. The output device(s) 514 such as a display, speakers, a printer, etc. are also included according to an aspect. The aforementioned devices are examples and others may be used. According to an aspect, the computing device 500 includes one or more communication connections 516 allowing communications with other computing devices 518. Examples of suitable communication connections 516 include, but are not limited to, radio frequency (RF) transmitter, receiver, and/or transceiver circuitry; universal serial bus (USB), parallel, and/or serial ports.

The term computer readable media, as used herein, includes computer storage media. Computer storage media include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (i.e., memory storage.) According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. According to an aspect, any such computer storage media are part of the computing device 500. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

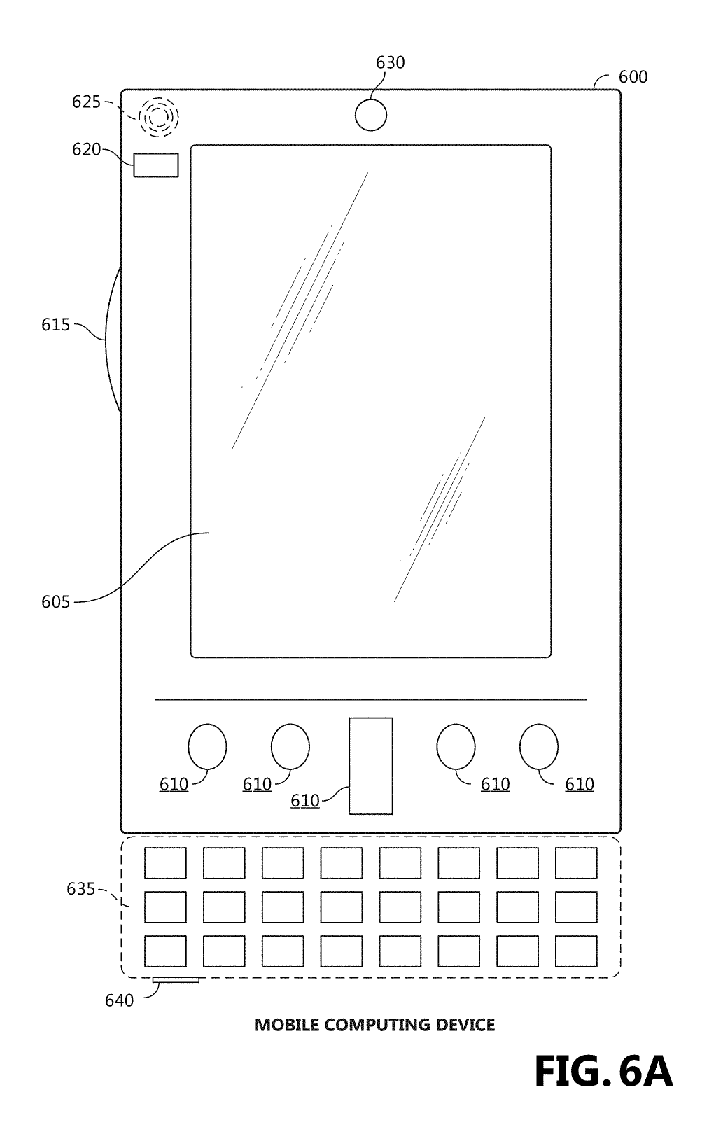

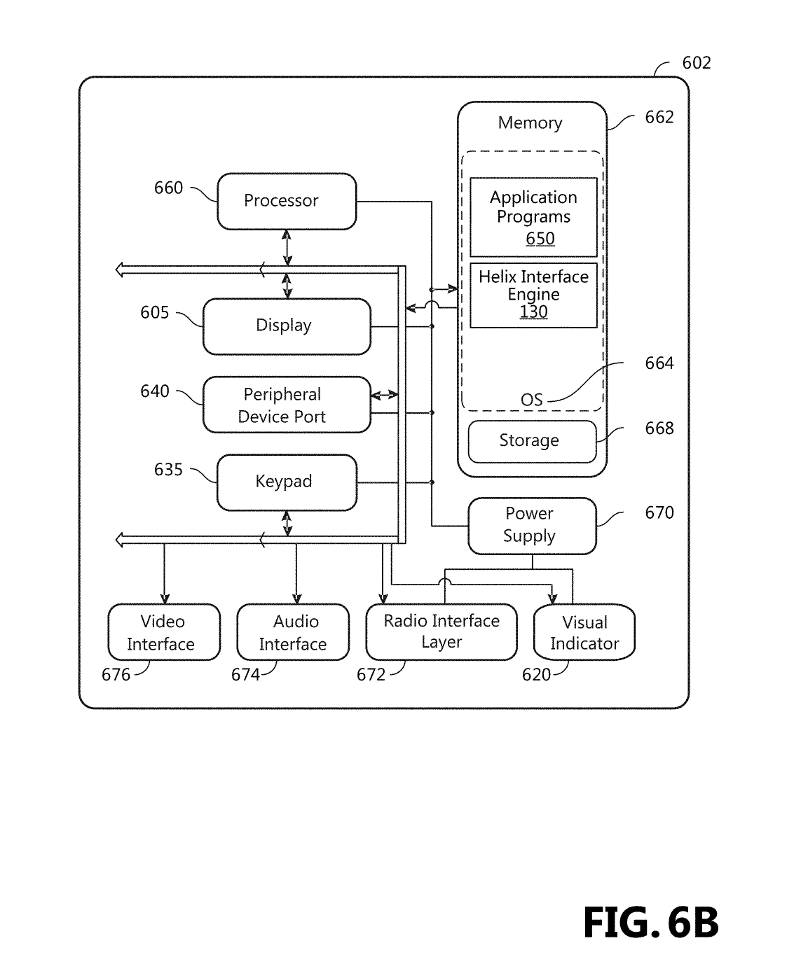

FIGS. 6A and 6B illustrate a mobile computing device 600, for example, a mobile telephone, a smart phone, a tablet personal computer, a laptop computer, and the like, with which aspects may be practiced. With reference to FIG. 6A, an example of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. According to an aspect, the display 605 of the mobile computing device 600 functions as an input device (e.g., a touch screen display). If included, an optional side input element 615 allows further user input. According to an aspect, the side input element 615 is a rotary switch, a button, or any other type of manual input element. In alternative examples, mobile computing device 600 incorporates more or fewer input elements. For example, the display 605 may not be a touch screen in some examples. In alternative examples, the mobile computing device 600 is a portable phone system, such as a cellular phone. According to an aspect, the mobile computing device 600 includes an optional keypad 635. According to an aspect, the optional keypad 635 is a physical keypad. According to another aspect, the optional keypad 635 is a “soft” keypad generated on the touch screen display. In various aspects, the output elements include the display 605 for showing a graphical user interface (GUI), a visual indicator 620 (e.g., a light emitting diode), and/or an audio transducer 625 (e.g., a speaker). In some examples, the mobile computing device 600 incorporates a vibration transducer for providing the user with tactile feedback. In yet another example, the mobile computing device 600 incorporates input and/or output ports, such as an audio input (e.g., a microphone jack), an audio output (e.g., a headphone jack), and a video output (e.g., a HDMI port) for sending signals to or receiving signals from an external device. In yet another example, the mobile computing device 600 incorporates peripheral device port 640, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one example of a mobile computing device. That is, the mobile computing device 600 incorporates a system (i.e., an architecture) 602 to implement some examples. In one example, the system 602 is implemented as a “smart phone” capable of running one or more applications (e.g., browser, e-mail, calendaring, contact managers, messaging clients, games, and media clients/players). In some examples, the system 602 is integrated as a computing device, such as an integrated personal digital assistant (PDA) and wireless phone.

According to an aspect, one or more application programs 650 are loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. According to an aspect, helix interface engine 130 is loaded into memory 662. The system 602 also includes a non-volatile storage area 668 within the memory 662. The non-volatile storage area 668 is used to store persistent information that should not be lost if the system 602 is powered down. The application programs 650 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

According to an aspect, the system 602 has a power supply 670, which is implemented as one or more batteries. According to an aspect, the power supply 670 further includes an external power source, such as an AC adapter or a powered docking cradle that supplements or recharges the batteries.

According to an aspect, the system 602 includes a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 650 via the operating system 664, and vice versa.

According to an aspect, the visual indicator 620 is used to provide visual notifications and/or an audio interface 674 is used for producing audible notifications via the audio transducer 625. In the illustrated example, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. According to an aspect, the system 602 further includes a video interface 676 that enables an operation of an on-board camera 630 to record still images, video stream, and the like.

According to an aspect, a mobile computing device 600 implementing the system 602 has additional features or functionality. For example, the mobile computing device 600 includes additional data storage devices (removable and/or non-removable) such as, magnetic disks, optical disks, or tape. Such additional storage is illustrated in FIG. 6B by the non-volatile storage area 668.

According to an aspect, data/information generated or captured by the mobile computing device 600 and stored via the system 602 are stored locally on the mobile computing device 600, as described above. According to another aspect, the data are stored on any number of storage media that are accessible by the device via the radio 672 or via a wired connection between the mobile computing device 600 and a separate computing device associated with the mobile computing device 600, for example, a server computer in a distributed computing network, such as the Internet. As should be appreciated such data/information are accessible via the mobile computing device 600 via the radio 672 or via a distributed computing network. Similarly, according to an aspect, such data/information are readily transferred between computing devices for storage and use according to well-known data/information transfer and storage means, including electronic mail and collaborative data/information sharing systems.

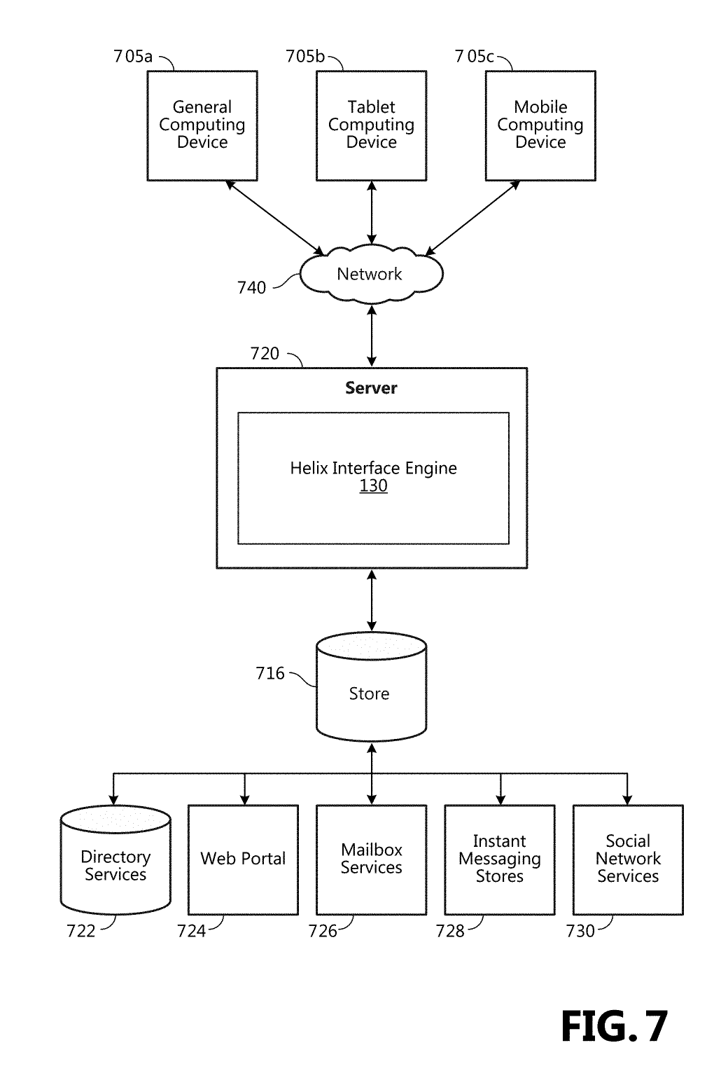

FIG. 7 illustrates one example of the architecture of a system for improving computer functionality by maintaining search context as described above. Content developed, interacted with, or edited in association with the helix interface engine 130 is enabled to be stored in different communication channels or other storage types. For example, various documents may be stored using a directory service 722, a web portal 724, a mailbox service 726, an instant messaging store 728, or a social networking site 730. The helix interface engine 130 is operative to use any of these types of systems or the like for improving computer functionality by maintaining search context, as described herein. According to an aspect, a server 720 provides the helix interface engine 130 to clients 705a,b,c. As one example, the server 720 is a web server providing the helix interface engine 130 over the web. The server 720 provides the helix interface engine 130 over the web to clients 705 through a network 740. By way of example, the client computing device is implemented and embodied in a personal computer 705a, a tablet computing device 705b or a mobile computing device 705c (e.g., a smart phone), or other computing device. Any of these examples of the client computing device are operable to obtain content from the store 716.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope.

We claim:

1. A system for improving computer functionality by maintaining search context, comprising:
a display device;
a processor; and
a memory storage device including instructions that when executed by the processor cause the system to:
display a search user interface on the display device, wherein the search user interface includes a plurality of search elements, wherein one search element belongs to a first level of search refinement and a group of search elements belong to a second level of search refinement;
in response to receiving a selection of a given search element of the plurality of search elements, wherein the given search element belongs to the second level of search refinement, query a search engine for results based on the given search element selected;
receive the results from the search engine;
in response to the results including categorized results, update the search user interface displayed on the display device, wherein the categorized results are displayed as further search elements of the plurality of search elements belonging to a third level of search refinement; and
in response to the results including uncategorized results, replace the search user interface displayed on the display device with a content card based on the uncategorized results.

2. The system of claim 1, wherein the instructions, when executed by the processor, further cause the system to:
in response to receiving a selection of a particular search element of the plurality of search elements, wherein the particular search element belongs to the third level of search refinement, query the search engine for additional results based on the particular search element selected;
in response to the additional results including additional categorized results, update the search user interface displayed on the display device, wherein the additional categorized results are displayed as additional search elements of the plurality of search elements belonging to a fourth level of search refinement; and
in response to the results including additional uncategorized results, replace the search user interface displayed on the display device with a content card based on the additional uncategorized results.

3. The system of claim 2, wherein display of the plurality of search elements is limited by an area the display device allocated for display of the search user interface, the instructions, when executed by the processor, further cause the system to:
helically shift display of the plurality of search elements in the search user interface based on a level of search refinement such that:
the one search element belonging to the first level of search refinement is removed from the search user interface;
the search elements belonging to the second level of search refinement are removed from the search user interface, except that the given search element is displayed in a location where the one search element was removed from display;
the search elements belonging to the third level of search refinement are displayed in locations where the search elements belonging to the second level of search refinement were removed from display; and
the search elements belonging to the fourth level of search refinement are displayed in locations where the search elements belonging to the third level of search refinement were removed from display.

4. The system of claim 1, wherein the instructions, when executed by the processor, further cause the system to:
in response to receiving a selection of a different search element of the plurality of search elements, wherein the different search element belongs to the second level of search refinement, query the search engine for different results based on the different search element selected;
in response to the different results including different categorized results, updating display of the search user interface, wherein the different categorized results are displayed as different search elements of the plurality of search elements belonging to the third level of search refinement that replace the further search elements that belong to the third level of search refinement; and
in response to the different results including different uncategorized results, replacing the search user interface from display with a different content card based on the different uncategorized results.

5. The system of claim 1, wherein the content card based on the uncategorized results is displayed, the instructions, when executed by the processor, further cause the system to:
in response to receiving a card command to dismiss the content card, remove the content card from display and displaying the search user interface as the search user interface was displayed prior to displaying the content card; and
in response to receiving a card command to explore the content card, display additional content related to the uncategorized results.

6. The system of claim 1, wherein the instructions, when executed by the processor, further cause the system to:
receive text in a text entry box included in the search user interface; and
wherein querying the search engine is based on a selected search element and the text received.

7. The system of claim 1, wherein the first level of search refinement is a keyword search, wherein the second level of search refinement defines a plurality of categories associated with each search element of the group of search elements belonging to the second level of search refinement, and wherein the third level of search refinement defines a plurality of subcategories of a category associated with the given search element selected that are associated with each search element belonging to the third level of search refinement.

8. A method for improving computer functionality by maintaining search context, comprising:
receiving a command to display a search user interface;
in response to receiving the command, displaying the search user interface, wherein the search user interface includes a plurality of search elements, wherein one search element belongs to a first level of search refinement and a group of search elements belong to a second level of search refinement;
receiving a selection of a given search element of the plurality of search elements, wherein the given search element belongs to the second level of search refinement;
querying a search engine for results based on the given search element selected;
receiving the results from the search engine;
in response to the results including categorized results, updating display of the search user interface, wherein the categorized results are displayed as further search elements of the plurality of search elements belonging to a third level of search refinement; and
in response to the results including uncategorized results, replacing the search user interface from display with a content card based on the uncategorized results.

9. The method of claim 8, further comprising:
receiving a selection of a particular search element of the plurality of search elements, wherein the particular search element belongs to the third level of search refinement;
querying the search engine for additional results based on the particular search element selected;
in response to the additional results including additional categorized results, updating display of the search user interface, wherein the additional categorized results are displayed as additional search elements of the plurality of search elements belonging to a fourth level of search refinement; and
in response to the results including additional uncategorized results, replacing the search user interface from display with a content card based on the additional uncategorized results.

10. The method of claim 9, wherein display of the plurality of search elements is limited by a size of display for the search user interface, further comprising:
helically shifting display of the plurality of search elements in the search user interface based on a level of search refinement such that:
the one search element belonging to the first level of search refinement is removed from the search user interface;
the search elements belonging to the second level of search refinement are removed from the search user interface, except that the given search element is displayed in a location where the one search element was removed from display;
the search elements belonging to the third level of search refinement are displayed in locations where the search elements belonging to the second level of search refinement were removed from display; and
the search elements belonging to the fourth level of search refinement are displayed in locations where the search elements belonging to the third level of search refinement were removed from display.

11. The method of claim 8, wherein search elements of the plurality of search elements are displayed in concentric rings based on levels of search refinement, wherein the search elements belonging to a higher level of search refinement are displayed in locations surrounding the search elements belonging to a lower level of search refinement.

12. The method of claim 11, wherein the search elements belonging to the highest level of search refinement that is displayed in the search user interface are displayed having a larger area than the search elements belonging to other levels of search refinement.

13. The method of claim 8, further comprising:
receiving a selection of a different search element of the plurality of search elements, wherein the different search element belongs to the second level of search refinement;
querying the search engine for different results based on the different search element selected;
in response to the different results including different categorized results, updating display of the search user interface, wherein the different categorized results are displayed as different search elements of the plurality of search elements belonging to the third level of search refinement that replace the further search elements that belong to the third level of search refinement; and
in response to the different results including different uncategorized results, replacing the search user interface from display with a different content card based on the different uncategorized results.

14. The method of claim 8, wherein the content card based on the uncategorized results is displayed, further comprising:
receiving a card command;
in response to the card command dismissing the content card, removing the content card from display and displaying the search user interface as the search user interface was displayed prior to displaying the content card; and
in response to the card command exploring the content card, displaying additional content related to the uncategorized results.

15. The method of claim 8, further comprising:
receiving text in a text entry box included in the search user interface; and
wherein querying the search engine is based on a selected search element and the text received.

16. The method of claim 8, wherein the first level of search refinement is a keyword search, wherein the second level of search refinement defines a plurality of categories associated with each search element of the group of search elements belonging to the second level of search refinement, and wherein the third level of search refinement defines a plurality of subcategories of a category associated with the given search element selected that are associated with each search element belonging to the third level of search refinement.

17. A storage device including instructions that when executed by a processor improve computer functionality by maintaining search context, comprising:
receiving a command to display a search user interface;
in response to receiving the command, displaying the search user interface, wherein the search user interface includes a text entry box and a plurality of search elements, wherein one search element is of a first level of search refinement associated with a keyword search and each remaining search element of the plurality of search elements belongs to a second level of search refinement and is associated with a category in which to search;
receiving a selection of a given search element of the plurality of search elements;
querying a search engine for results based on the given search element selected and any text entered in the text entry box;
receiving the results from the search engine;
in response to the results including categorized results, updating the search user interface, wherein the categorized results are displayed as further search elements of the plurality of search elements, wherein each of the further search elements belongs to a third level of search refinement and is associated with a subcategory in which to search associated with the given search element; and
in response to the results including uncategorized results, replacing the search user interface from display with a content card based on the uncategorized results.

18. The storage device of claim 17, wherein display of the plurality of search elements is limited by a size of display for the search user interface, further comprising:
helically shifting display of the plurality of search elements in the search user interface based on a level of search refinement such that:
a sole search element belonging to the first level of search refinement is removed from the search user interface;
search elements belonging to the second level of search refinement are removed from the search user interface, except that the given search element is displayed in a location where the one search element was removed from display; and
the search elements belonging to the third level of search refinement are displayed in locations where the search elements belonging to the second level of search refinement were removed from display.

19. The storage device of claim 17, receiving a selection of a different search element of the plurality of search elements, wherein the different search element belongs to the second level of search refinement;
querying the search engine for different results based on the different search element selected and any text entered in the text entry box;
in response to the different results including different categorized results, updating display of the search user interface, wherein the different categorized results are displayed as different search elements of the plurality of search elements belonging to the third level of search refinement that replace the further search elements that belong to the third level of search refinement; and
in response to the different results including different uncategorized results, replacing the search user interface from display with a different content card based on the different uncategorized results.

20. The storage device of claim 17, wherein the content card based on the uncategorized results is displayed, further comprising:
receiving a card command, including a gesture or a selection of a command interface;
in response to the card command dismissing the content card, removing the content card from display and displaying the search user interface as the search user interface was displayed prior to displaying the content card; and
in response to the card command exploring the content card, displaying additional content related to the uncategorized results.
